(19) United States
(12) Patent Application Publication
(10) Pub. No.: US 2014/0221055 A1
(43) Pub. Date: Aug. 7, 2014

(54) MOBILE ELECTRONIC DEVICE HOLDER

(71) Applicant: FU-CHI WU, NORTHRIDGE, CA (US)

(72) Inventor: FU-CHI WU, NORTHRIDGE, CA (US)

(21) Appl. No.: 13/759,116

(22) Filed: Feb. 5, 2013

(51) Int. Cl. H04M 1/02

(52) U.S. Cl. CPC H04M 1/0281
USPC 455/575.6

(57) ABSTRACT

A mobile electronic device holder includes a holder body configured for holding a smart phone or tablet PC, and fastening straps inserted through insertion slots at the back side of the holder body and respectively provided with a buckle ring and a hook and loop pad at two opposite ends thereof. By means of the buckle ring and the hook and loop pad, the two ends of each fastening strap can be joined together and secured to one finger of the user so that the user can operate the smart phone or tablet PC to take pictures conveniently and steadily with one single hand.

### BACKGROUND OF THE INVENTION

1. Field of the Invention

The present invention relates to mobile electronic device holder configured for holding a mobile electronic device, for example, smart phone or tablet PC, and more particularly, to a mobile electronic device holder, which comprises a holder body configured for holding a smart phone or tablet PC, and fastening straps inserted through respective sets of insertion slots at the back side of the holder body and respectively provided with a buckle ring and a hook and loop pad at two opposite ends thereof for fastening the holder body to one finger of the user so that the user can operate the smart phone or tablet PC to take pictures conveniently and steadily with one single hand.

2. Description of the Related Art

Following fast development of electronic and communication technologies and rise of living standards, the use of mobile phones has been quite common, and almost everybody has a mobile phone. In addition to the basic function for enabling the user to dial a telephone number and to send a message, a smart phone can be used to take pictures, to record videos, to connect to the Internet for data searching, to play music and video games, and to watch videos. The camera of a smart phone provides sharp, high-definition imagery. However, the quality of pictures and videos obtained by an ordinary smart phone is poor due to that when using an ordinary smart phone, one shall have to hold the body of the smart phone with one hand and to touch the touch-sensitive control zone of the touch screen of the smart phone with the other hand, and a rotary displacement of the smart phone is naturally produced subject to the thrust of the finger touching the touch-sensitive control zone against user's instinct to keep the body in balance. Thus, the smart phone can vibrate at this time, affecting photo shooting quality. Further, because a smart phone has a small size and smooth surfaces and edges, it is difficult to take a picture or recording a video with one single hand when using a smart phone.

Further, when using a smart phone or tablet PC, the user needs to hold the smart phone or tablet PC with one hand and to touch the touch-sensitive control zone of the touch screen with the other hand, making the operation difficult. When a tablet PC is horizontally placed on a table or flat surface, the user cannot view the screen of the tablet PC comfortably. Further, one may use a smart phone or tablet PC to search data when standing on the walking. Further, there are no suitable commercial mobile electronic device holder designs that can be positively secured to a bicycle or motorcycle for allowing the bicycle or motorcycle rider to use a smart phone or tablet PC conveniently. Thus, when riding a bicycle or motorcycle, the bicycle or motorcycle rider cannot see the caller's information on the display of his or her smart phone or tablet PC or use the GPS navigation function of his or her smart phone or tablet PC.

Therefore, it is desirable to provide a smart phone/tablet PC holder, which enables a smart phone or tablet PC to be detachably secured to the hand or a person or the handlebar of a bicycle or motorcycle, or adjustably supported on a table or flat surface in a tilted position convenient for applications.

### SUMMARY OF THE INVENTION

The present invention has been accomplished under the circumstances in view. It is the main object of the present invention to provide a mobile electronic device holder, which can be conveniently fastened to one finger of the user to hold a smart phone/tablet PC so that the user can operate the smart phone/tablet PC to take pictures steadily with one single hand.

To achieve this and other objects of the present invention, a mobile electronic device holder comprises a holder body configured for holding a smart phone or tablet PC, and fastening straps inserted through insertion slots at the back side of the holder body and respectively provided with a buckle ring and a hook and loop pad at two opposite ends thereof. By means of the buckle ring and the hook and loop pad, the two ends of each fastening strap can be joined together and secured to one finger of the user so that the user can operate the smart phone or tablet PC to take pictures conveniently and steadily with one single hand.

Further, by means of the hook and loop pad, each fastening strap can be arranged in the form of a loop for supporting the holder body and the loaded smart phone/tablet PC on a flat surface obliquely in a horizontal or vertical condition.

### BRIEF DESCRIPTION OF THE DRAWING

FIG. 1 is an exploded view of a mobile electronic device holder in accordance with the present invention.

FIG. 2 is an exploded view of the mobile electronic device holder and a smart phone in accordance with the present invention.

FIG. 3 is a schematic drawing of the present invention, illustrating the fastening straps respectively arranged into a loop.

FIG. 4 is a schematic applied view of the present invention, illustrating the mobile electronic device holder fastened to a finger of a user and a smart phone held in the holder body.

FIG. 5 is a schematic applied view of the present invention, illustrating the fastening straps respectively arranged into transverse loops and rested on a tabletop and a smart phone held in the holder body.

FIG. 6 is a schematic applied view of an alternate form of the present invention, illustrating the fastening straps respectively arranged into longitudinal loops and rested on a tabletop and a smart phone held in the holder body.

FIG. 7 is a perspective view of another alternate form of the present invention, illustrating the holder body configured for supporting a tablet PC.

FIG. 8 illustrates a hard support fastened to one upper fastening strap of the mobile electronic device holder and kept perpendicular to the holder body and a tablet PC held in the holder body of the mobile electronic device holder and supported on the hard support at a tabletop in a tilted position.

FIG. 9 illustrates a hard support fastened to one lower fastening strap of the mobile electronic device holder and kept perpendicular to the holder body and a tablet PC held in the holder body of the mobile electronic device holder and supported on the hard support at a tabletop in a tilted position.

FIG. 10 illustrates a hard support fastened to one lower fastening strap of the mobile electronic device holder and kept in a parallel manner relative to the holder body and a tablet PC held in the holder body of the mobile electronic device holder and supported on the hard support at a tabletop in a tilted position.

FIG. 11 is a schematic applied view of the present invention, illustrating the mobile electronic device holder fastened to the handlebar of a bicycle in a transverse direction and a smart phone held in the holder body of the mobile electronic device holder.

FIG. 12 is a schematic applied view of the present invention, illustrating the mobile electronic device holder fastened to the handlebar of a bicycle in a longitudinal direction and a tablet PC held in the holder body of the mobile electronic device holder.

### DETAILED DESCRIPTION OF THE PREFERRED EMBODIMENT

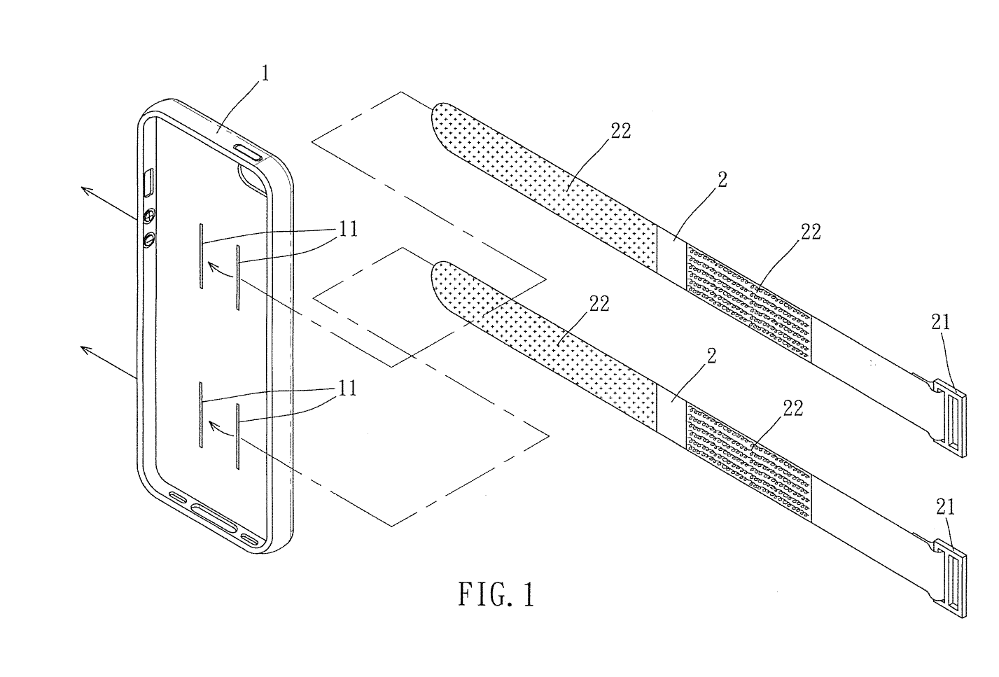

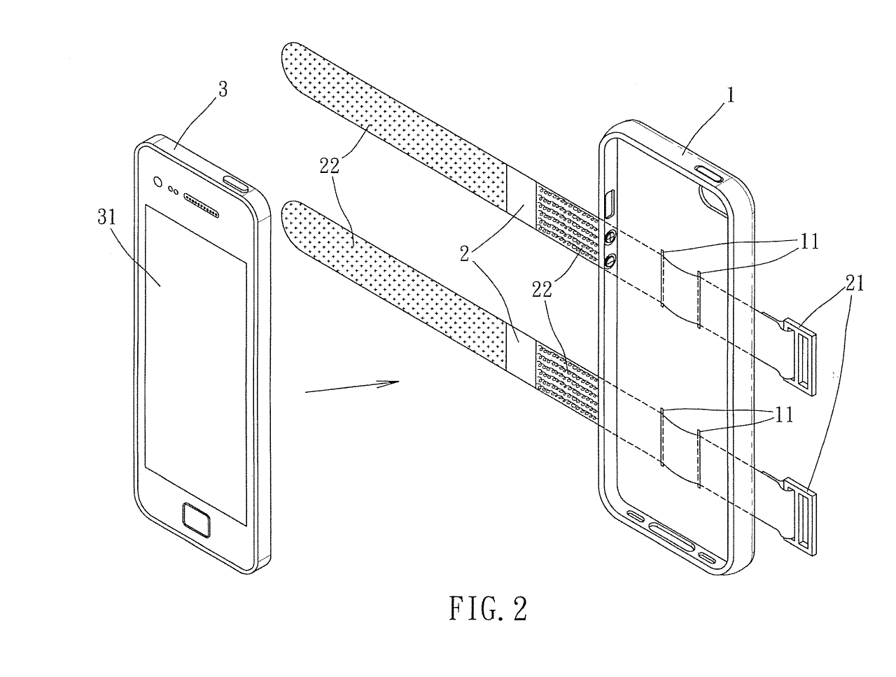

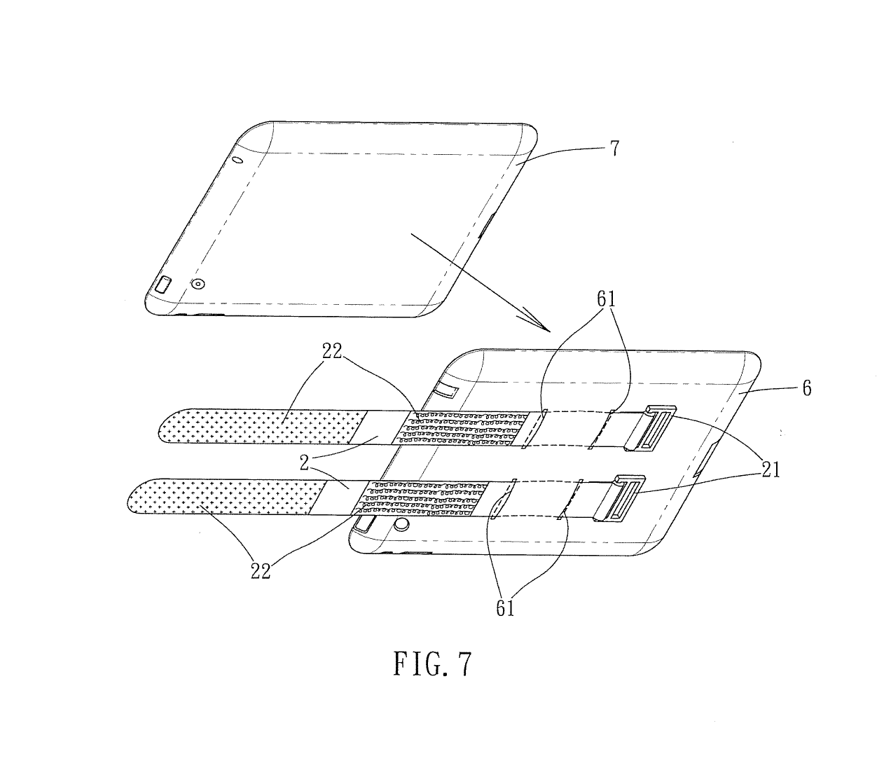

Referring to FIGS. 1, 2 and 7, a mobile electronic device PC holder in accordance with the present invention is shown.

The mobile electronic device holder comprises a holder body 1;6 for holding a smart phone 3 or tablet PC 7, at least one, for example, two fastening straps 2 mounted in the back side of the holder body 1;6. The holder body 1;6 comprises at least one, for example, two sets of insertion slots 11;61. In this embodiment, the insertion slots 11;61 extend in a longitudinal direction relative to the holder body 1;6. The two fastening straps 2 are respectively inserted through the insertion slots 11;61 of the holder body 1;6 in a transverse direction relative to the holder body 1;6.

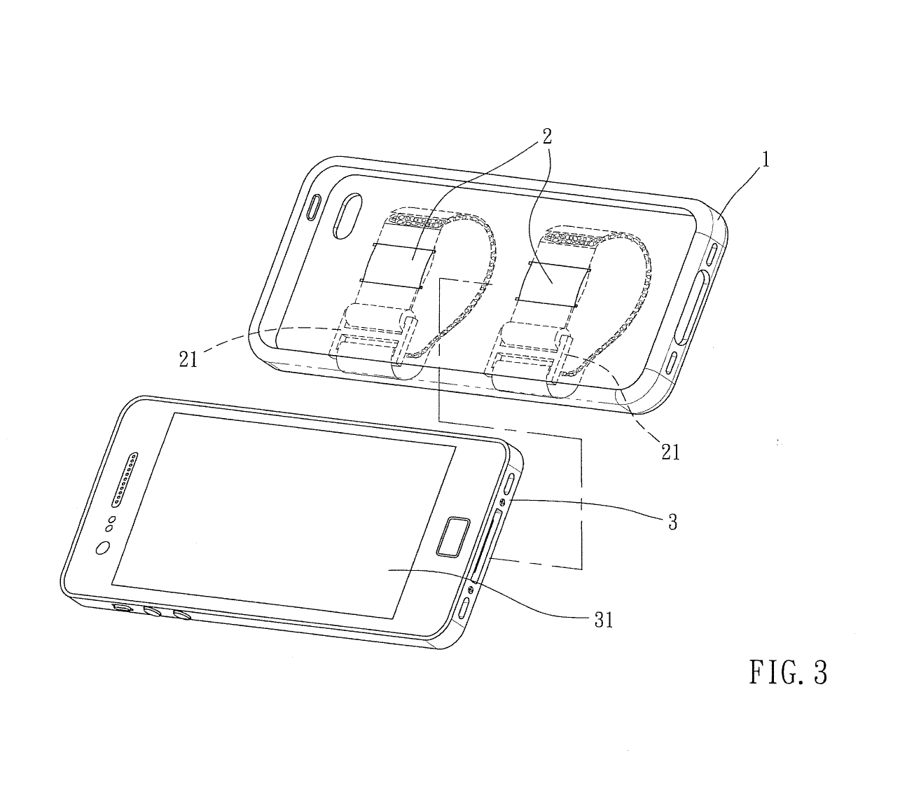

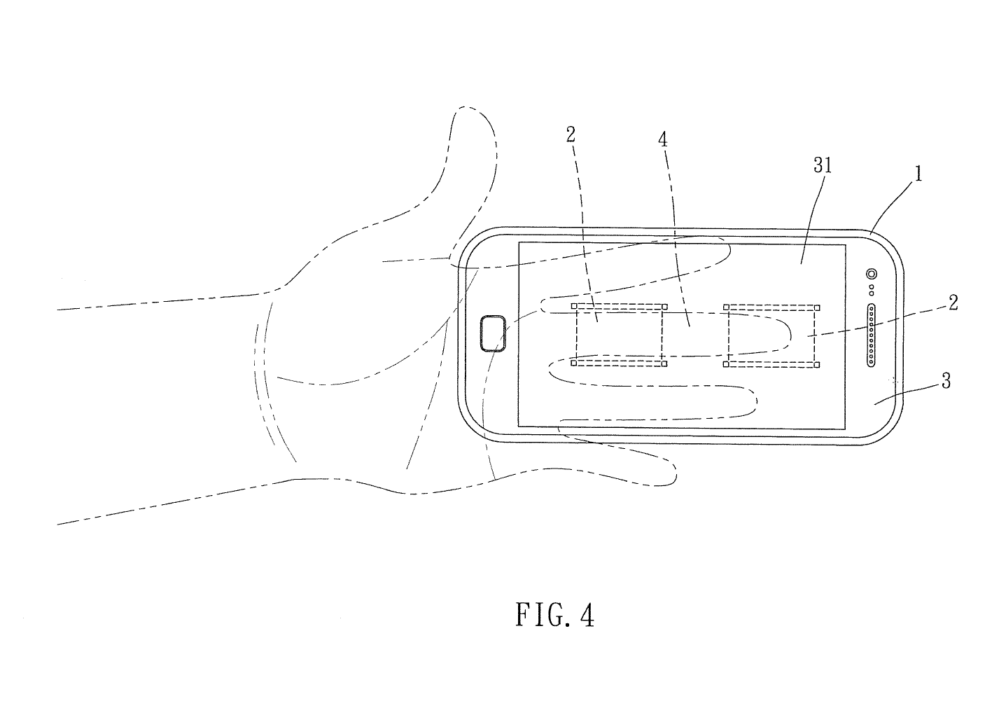

The fastening straps 2 can be made having a respective buckle ring 21 at one end thereof. Alternatively, the fastening straps 2 can be made without the buckle ring 21. The other end of each fastening strap 2 carrying a buckle ring can be inserted through the associating buckle ring 21. Further, the other end of each fastening strap 2 is provided with a hook and loop pad 22 or buckle ring positioning means. By means of the hook and loop pad 22 or buckle ring positioning means, the fastening straps 2 can be fastened to a finger 4 of the user (see FIGS. 3 and 4), i.e., the hook and loop pad 22 or buckle ring positioning means can join the ends of each fastening strap 2 to secure the holder body 1 or 6 positively to a finger 4 of the user. At this time, the user can use one single finger of the hand holding the holder body 1 to touch the touch-sensitive control zone of the touch screen 31 of the smart phone 3 in the holder body 1 in taking a picture, and the smart phone 3 is positively held in position without vibration. Thus, when the user operates the smart phone 3 to take a picture or to record images, the smart phone 3 will not fall from the user's hand.

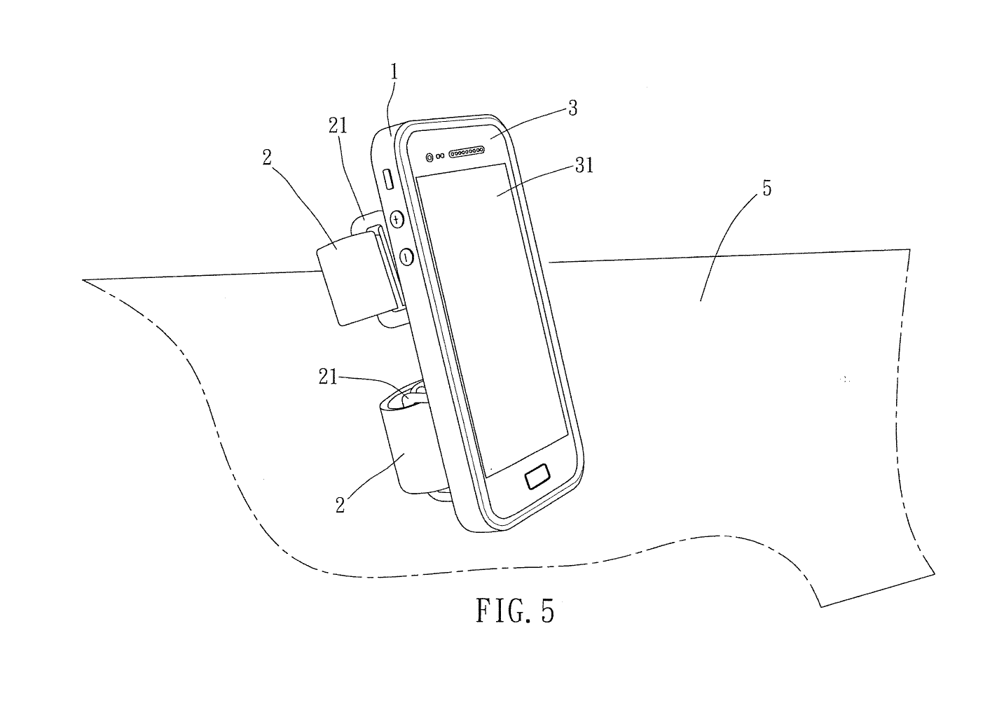

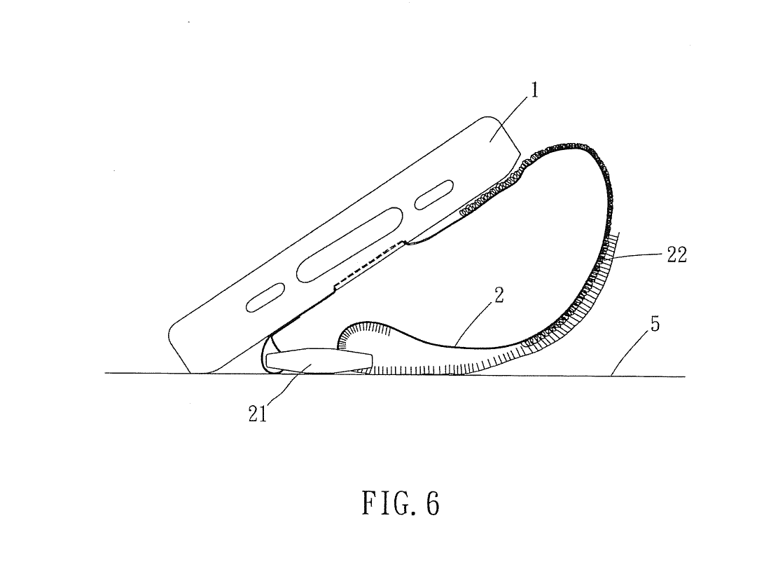

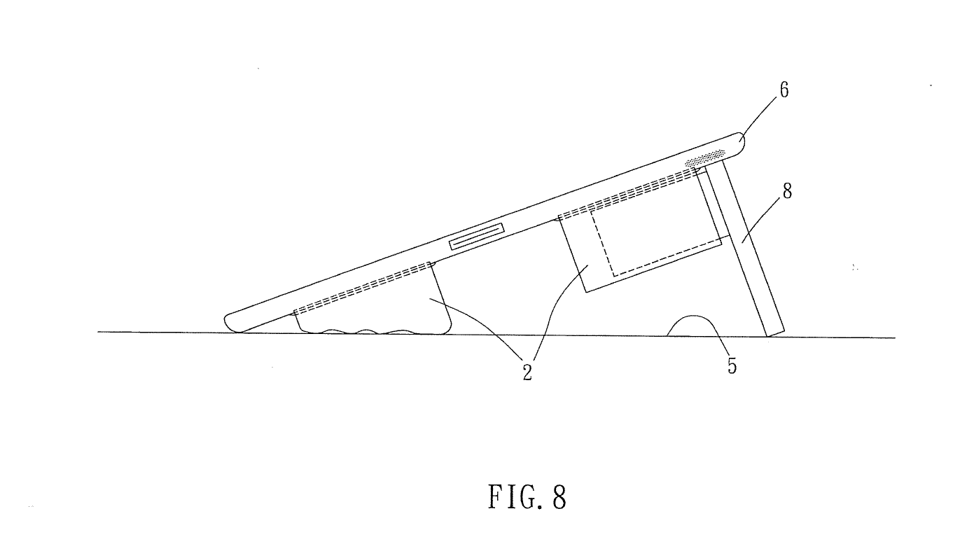

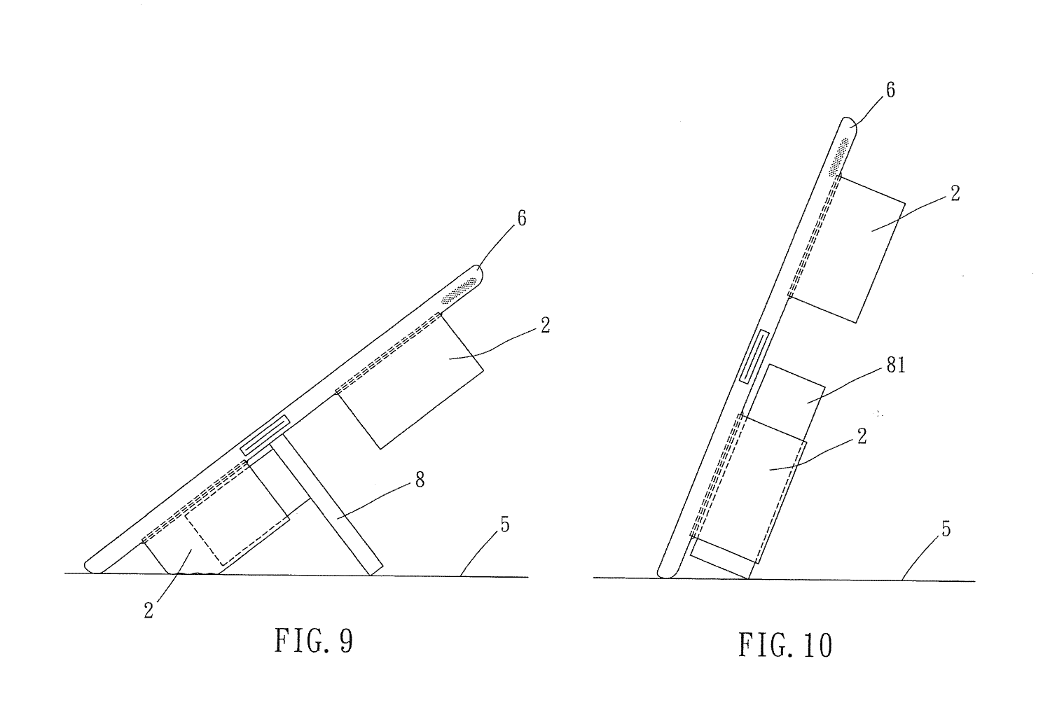

Further, as shown in FIGS. 5 and 6, the insertion slots 11;61 can be configured to extend in a transverse direction relative to the holder body 1;6. In this case, the two fastening straps 2 are respectively inserted through the insertion slots 11;61 of the holder body 1;6 in a longitudinal direction relative to the holder body 1;6. Further, by means of the hook and loop pad 22 or buckle ring positioning means to join the ends of each fastening strap 2, each fastening strap 2 can be secured in the form of a loop. At this time, the user can adjust the size of the loop to directly support the holder body 1 and the smart phone 3 or tablet PC 7 on a tabletop 5 in a tilted position. Further, one fastening strap 2 can be fastened to a hard support 8;81, enabling the hard support 8;81 to support the holder body 6 and a tablet PC 7 on a tabletop 5 obliquely in a vertical or horizontal position (see FIGS. 8, 9 and 10).

Further, the fastening straps 2 can be wholly or partially made from a non-slip material to avoid slipping.

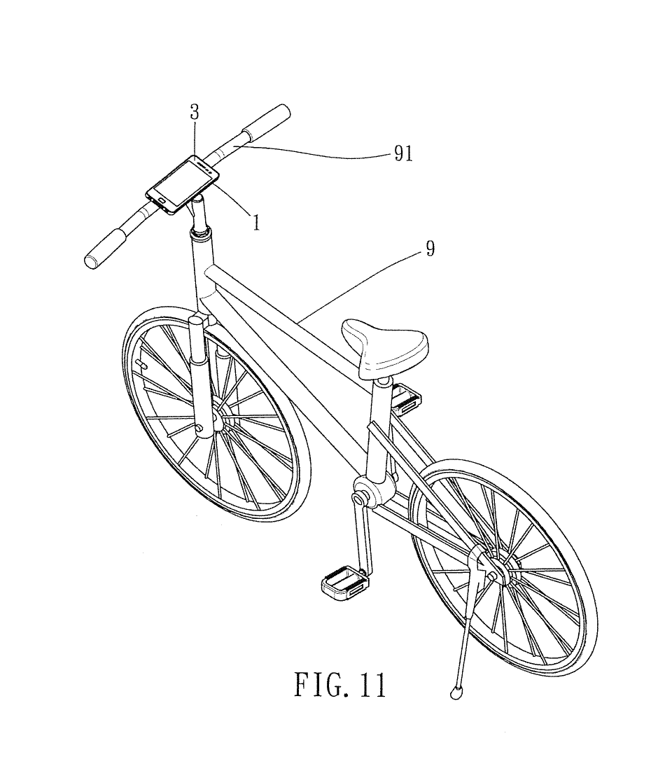

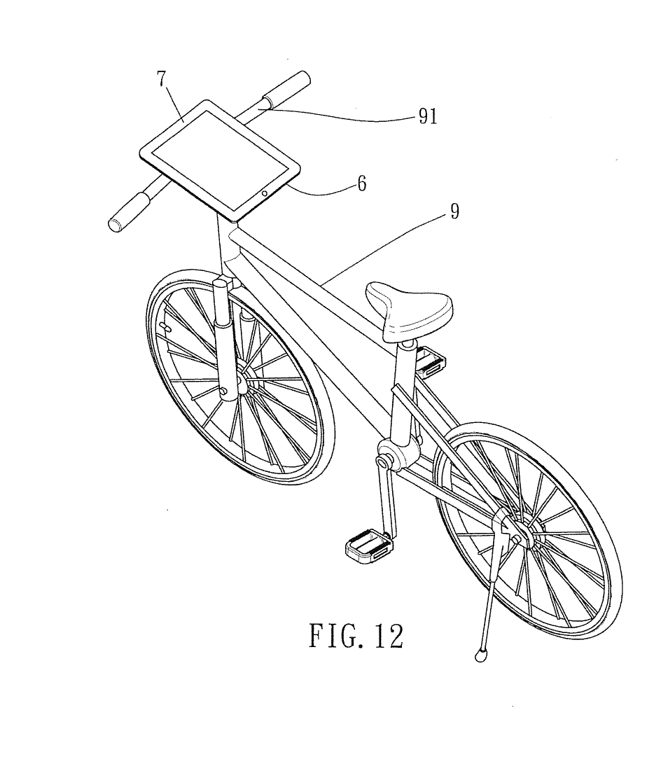

Further, by means of the fastening straps 2, the holder body 1;6 can be fastened to the handlebar 91 of a bicycle 9 to carry a smart phone 3 or tablet PC 7 as a navigation aid (see FIGS. 11 and 12).

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mobile electronic device holder, comprising:
a holder body configured for holding a mobile electronic device, said holder body comprising at least one set of insertion slots; and
at least one fastening strap respectively inserted through said at least one set of insertion slots of said holder body and adapted for securing said holder body to an external object, each said fastening strap comprising opposing first end and second, and at least one hook and loop pad disposed at one of said first end and said second end and adapted for joining said first end and said second end to secure said holder body to a finger of a person.

2. The mobile electronic device holder as claimed in claim 1, wherein each said insertion slot of said holder body extends in a transverse direction relative to said holder body;
the at least one hook and loop pad of each said fastening strap enables the respective said fastening strap to be arranged a transverse loop for supporting said holder body on a flat surface obliquely in a horizontal position.

3. The mobile electronic device holder as claimed in claim 1, wherein each said insertion slot of said holder body extends in a longitudinal direction relative to said holder body; the at least one hook and loop pad of each said fastening strap enables the respective said fastening strap to be arranged a longitudinal loop for supporting said holder body on a flat surface obliquely in a vertical position.

4. The mobile electronic device holder as claimed in claim 1, wherein each said fastening strap further comprises a buckle ring located at the other of said first end and said second end for joining said first end and said second end.

5. The mobile electronic device holder as claimed in claim 1, further comprising a hard support member fastenable to one said fastening strap for supporting said holder body on a flat surface in a tilted position.

6. The mobile electronic device holder as claimed in claim 5, wherein aid hard support member is a daily consumer product.

7. The mobile electronic device holder as claimed in claim 1, wherein said holder body is configured to hold a smart phone, and said at least one fastening strap is adapted to secure said holder body to a handlebar of a bicycle for enabling the smart phone that is held in said holder body to be used as a navigation aid.

8. The mobile electronic device holder as claimed in claim 1, wherein said holder body is configured to hold a tablet PC, and said at least one fastening strap is adapted to secure said holder body to a handlebar of a bicycle for enabling the tablet PC that is held in said holder body to be used as a navigation aid.

9. The mobile electronic device holder as claimed in claim 1, wherein each said fastening strap is made from a non-slip material.
